(19) United States
(12) Patent Application Publication
(10) Pub. No.: US 2006/0006032 A1
(43) Pub. Date: Jan. 12, 2006

(54) Reinforced viscoelastic system

(76) Inventors: Mike Loth, Orland Park, IL (US); Ahid Nashif, Cincinnati, OH (US); Bryan Tullis, Chicago, IL (US)

Correspondence Address: Quinn Law Group, PLLC., 39555 Orchard Hill Place, Suite 520, Novi, MI, 48375, US

(21) Appl. No.: 11/015,493

(22) Filed: Dec. 17, 2004

Related U.S. Application Data
(60) Provisional application No. 60/586,652, filed on Jul. 9, 2004.

(51) Int. Cl. F16F 13/00

(52) U.S. Cl. 188/379; 267/83; 267/140.4

(57) ABSTRACT

The present invention provides a vibration damping structure comprising a core adjacent a first constraining layer. The core comprises a continuous strengthening layer disposed between first and second viscoelastic layers. The first constraining layer rests adjacent the first viscoelastic layer. A second constraining may rest adjacent the second viscoelastic layer, thereby sandwiching the core to vary damping characteristics of the damping structure. The strengthening layer comprises any material significantly stiffer than the viscoelastic material, thereby increasing the overall stiffness of the core. Addition of the strengthening layer substantially increases shearing to significantly increase energy dissipation.

### CROSS-REFERENCE TO RELATED APPLICATION

This application claims the benefit of U.S. Provisional Application 60/586,652 filed Jul. 9, 2004 which is hereby incorporated by reference in its entirety.

### TECHNICAL FIELD

The present invention relates to damping structures for diminishing unwanted vibrations within a mechanical system, and particularly to damping structures utilizing a viscoelastic material.

### BACKGROUND OF THE INVENTION

Attaching a layer of viscoelastic material to component parts of a mechanical system for reducing unwanted vibrations is well known throughout the mechanical arts. As one example, frictional sliding between a brake shoe and a rotor in a conventional disc brake can cause detrimental vibrations within the brake shoe. U.S. Pat. No. 4,447,493 discloses a typical damping structure attached to the brake shoe to diminish these vibrations. The damping structure comprises a viscoelastic layer sandwiched between a pair of constraining layers. The ability of the damping structure to damp vibrations is known as its “loss factor”, with a higher loss factor indicating greater damping capability. The loss factor for a given damping structure is a function of both temperature and vibrational frequency within the damping structure.

A force applied to the constraining layers, such as the force from vibrations within the brake shoe, drives the viscoelastic material into shear along the constraining layers, thereby converting a substantial amount of vibrational energy into heat. Increasing the shear within the damping structure, therefore, also increases the energy dissipating characteristics therein. It is thus desirable to provide a damping structure with increased shear to increase the loss factor.

Typical viscoelastic materials, for example, acrylics, silicones, rubbers and other plastics, have a relatively low stiffness, which can cause undesirable compression within the damping structure. Within the disc brake, for example, a damping structure with less stiffness will create a condition known as “soft brakes”, requiring more pedal pressure to initiate braking. While reducing the thickness of the viscoelastic layer creates a stiffer assembly, a reduction in the loss factor also results. Therefore, it is desirable to provide a damping structure with an increased overall stiffness without sacrificing damping efficiency.

### SUMMARY OF THE INVENTION

Accordingly, the present invention provides a vibration damping structure comprising a core adjacent a constraining layer. A second constraining layer may sandwich the core to vary damping characteristics of the damping structure. The core comprises a continuous strengthening layer disposed between first and second viscoelastic layers. The strengthening layer comprises any material significantly stiffer than the viscoelastic material, thereby increasing the overall stiffness of the core. Addition of the strengthening layer substantially increases shearing to significantly increase energy dissipation.

### BRIEF DESCRIPTION OF THE DRAWINGS

The above features and advantages and other features and advantages of the present invention are readily apparent from the following detailed description of the best modes for carrying out the invention when taken in connection with the accompanying drawings, wherein:

FIG. 1 is a schematic enlarged cross-sectional view of a prior art viscoelastic damping structure;

FIG. 2 is a schematic enlarged cross-sectional view of a viscoelastic damping structure according to the present invention;

FIG. 3 is a graph showing loss factors varying with temperature for the prior art damping structure of FIG. 1 at vibrational modes a through d; and

FIG. 4 is a graph showing loss factors varying with temperature for the present damping structure of FIG. 2 at vibrational modes a through d.

### DESCRIPTION OF THE PREFERRED EMBODIMENTS

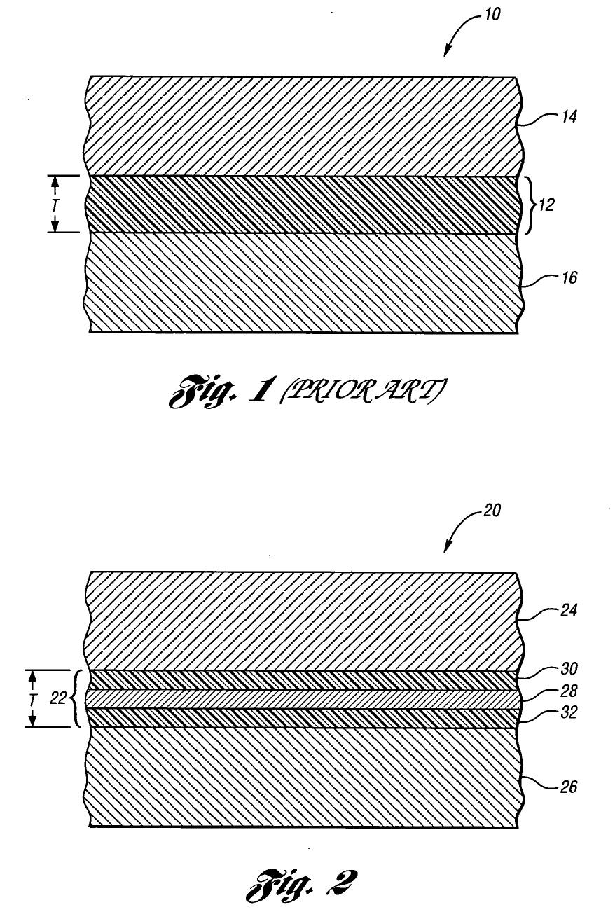

Referring to the drawings, FIG. 1 illustrates a prior art vibration damping structure 10. The damping structure 10 comprises a core 12 of thickness T sandwiched between first and second constraining layers 14, 16. Typically, the constraining layers 14, 16 are substantially thicker than the core 12 and comprise a metal such as steel, although any significantly rigid material may be used. The core 12 comprises a viscoelastic material as known in the art.

FIG. 2 illustrates a vibration damping structure 20 in accordance with the present invention. While FIG. 2 depicts a rectangular damping structure 20 for ease of comparison with the prior art, the damping structure 20 may comprise any shape without changing the inventive concept.

The damping structure 20 includes a core 22 fixed to a first constraining layer 24. The present invention may also be practiced with a second constraining layer 26, as shown in FIG. 2 and described herein. It should be noted, however, that the second constraining layer is not necessary for operation. The core 22 of the present invention comprises a continuous strengthening layer 28 disposed between first and second viscoelastic layers 30, 32. The strengthening layer 28 comprises any material significantly stiffer than the viscoelastic material to increase the overall stiffness of the core 22. Preferably, addition of the strengthening layer 28 does not increase the core 22 thickness, T, as compared to the prior art, which means less viscoelastic material need be used. Reducing the amount of low stiffness material within the core 22 increases the overall stiffness of the core 22 as described below. The thickness of all three layers 28, 30, 32 comprising the core 22 may be adjusted to provide optimal damping within a temperature range required for a specific application. Additionally, the viscoelastic materials chosen for the first and second viscoelastic layers 30, 32 need not be identical.

In the prior art damping structure 10, shearing occurs between the core 12 and each of the constraining layers 14, 16. Particularly, the constraining layers 14, 16 undergo deformation due to vibrational forces. Because the core 12 is bonded to the constraining layers 14, 16, the deformation is transferred thereto. However, since the core 12 is constrained, the deformation forces must travel perpendicularly across the thickness of the viscoelastic material comprising the core 22. This shearing inside the core 22 absorbs the vibration energy of the load and dissipates it into heat, thereby damping the motion of the constraining layers 14, 16 and anything attached thereto.

Addition of the strengthening layer 28 in the damping structure 20 of the present invention provides shearing between the first constraining layer 24 and the first viscoelastic layer 30, the first viscoelastic layer 30 and the strengthening layer 28, and the strengthening layer 28 and the second viscoelastic layer 32. If a second constraining layer 26 is present, additional shearing occurs between the second viscoelastic layer 32 and the second constraining layer 26. By substantially increasing shearing, the present invention increases energy dissipation, thereby increasing the loss factor for the damping structure 20 despite using less viscoelastic material.

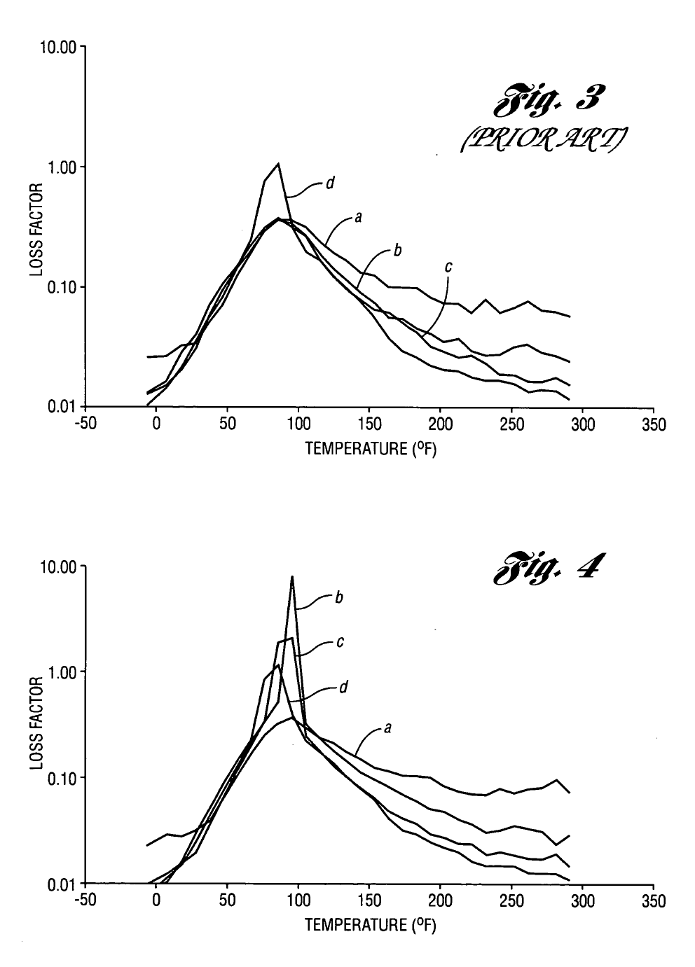

Using the Oberst Method, loss curves were created for both the prior art damping structure 10 and the damping structure 20 of the present invention at several vibrational modes. For both damping structures 10, 20, an identical viscoelastic material was used for testing. FIG. 3 shows the resulting loss curves for the prior art damping structure 10, while FIG. 4 shows the loss curves for the damping structure 20 of the present invention. Four vibrational modes are labeled as a through d in FIGS. 3 and 4. A comparison of FIGS. 3 and 4 reveals that greater loss factors are achieved with the damping structure 20 of the present invention. That is, FIG. 4 shows that replacing a portion of the viscoelastic material in the core 22 with the strengthening layer 28 increased the loss factor quite significantly through certain temperature ranges.

Addition of the strengthening layer 28 increases the overall stiffness of the core 22 as shown in the following example. Assuming a single layer damping structure 20 having a cylindrical shape with diameter D, each layer 28, 30, 32 of the core 22 has a static stiffness K defined as:

$$K = \frac{E ( π {D}^{2} )}{4 H} [ 1 + {β ( \frac{D}{4 H} )}^{2} ] ,$$

where H is the thickness of the layer, E is the Young's modulus for the material comprising the layer, and β is a correction factor, with

$$[ 1 + {β ( \frac{D}{4 H} )}^{2} ]$$

serving as a correction term for the finite height to diameter ratio of the layer. For unfilled polymers, β is typically around 2.

Using the equation given above, the static stiffness Kₚᵣᵢₒᵣₐᵣₜ for the core 12 of the prior art damping structure 10 can be calculated. For ease of calculation and comparison, let us assume D=1 mm and H=0.75 mm, with β=2. Therefore,

$$\begin{matrix}{K}_{priorart} \approx \frac{E ( {π ( 1 )}^{2} )}{4 ( 0.75 )} [ 1 + 2 {( \frac{( 1 )}{4 ( 0.75 )} )}^{2} ] \\ \approx E \frac{{( 3.14 )}^{2}}{3} ( 1 + 2 {( 0.33 )}^{2} ) \\ \approx 3.29 E ( 1.22 ) \\ \approx 4 E .\end{matrix}$$

It can thus be seen that the total static stiffness Kₚᵣᵢₒᵣₐᵣₜ for the core 12 of the prior art damping structure 10 is approximately four times the Young's modulus of the viscoelastic material comprising the core 12.

Since the core 22 of the damping structure 20 of the preferred embodiment of the present invention comprises three layers, 28, 30, 32, a stiffness K must be calculated for each layer. For ease of calculation and comparison, let us assume that the core 22 has a D=1 mm and comprises three layers each having H=0.25 mm, for an overall core height T of 0.75 mm as with the previous example. Additionally, let us further assume that the first and second viscoelastic layers 30, 32 comprise the same viscoelastic material of Young's modulus E. Finally, since the strengthening layer 28 comprises any material significantly stronger than the viscoelastic material comprising the viscoelastic layers, let us assume that the Young's modulus of the strengthening layer 28 is 50E. This term was only chosen for ease of calculation; it should not be assumed that in the preferred embodiment, the strengthening layer 28 is exactly fifty times stiffer than the viscoelastic layers 30, 32.

First, it is possible to calculate the stiffness of the first and second viscoelastic layers 30, 32, K_{viscoelastic} as follows:

$$\begin{matrix}{K}_{viscoelastic} \approx \frac{E ( {π ( 1 )}^{2} )}{4 ( 0.25 )} [ 1 + 2 {( \frac{( 1 )}{4 ( 0.25 )} )}^{2} ] \\ \approx E \frac{{( 3.14 )}^{2}}{1} ( 1 + ( 2 {( 1 )}^{2} ) \\ \approx 10 E ( 3 ) \\ \approx 30 E .\end{matrix}$$

Next, the stiffness of the strengthening layer 28, K_{strengthening}, is calculated:

$$\begin{matrix}{K}_{strengthening} \approx \frac{50 E ( {π ( 1 )}^{2} )}{4 ( 0.25 )} [ 1 + 2 {( \frac{( 1 )}{4 ( 0.25 )} )}^{2} ] \\ \approx 50 E \frac{{( 3.14 )}^{2}}{1} ( 1 + ( 2 {( 1 )}^{2} ) \\ \approx 493 E ( 3 ) \\ \approx 1478 E .\end{matrix}$$

To find the total static stiffness of the core, Kₜₒₜₐₗ, the core 22 is modeled as three springs connected in series, with each layer 28, 30, 32 representing a spring. Therefore,

$$\begin{matrix}\frac{1}{{K}_{total}} = \frac{1}{{K}_{viscoelastic}} + \frac{1}{{K}_{strengthening}} + \frac{1}{{K}_{viscoelastic}} , or \\ \frac{1}{{K}_{total}} \approx \frac{2}{{K}_{viscoelastic}} + \frac{1}{{K}_{strengthening}} .\end{matrix}$$

By substituting the values calculated above, it can be seen that:

$$\begin{matrix}\frac{1}{{K}_{total}} \approx \frac{2}{30 E} + \frac{1}{1478 E} \\ \approx \frac{2 ( 1478 )}{44340 E} + \frac{30}{44340 E} \\ \approx \frac{2986}{44340 E} \\ \approx \frac{0.067}{E} .\end{matrix}$$

Taking the reciprocal of both terms, it can be seen that Kₜₒₜₐₗ≈15E. Therefore, the static stiffness of the core 22 including the strengthening layer 28 is approximately fifteen times the Young's modulus of the viscoelastic material comprising the first and second viscoelastic layers 30, 32. Recall that the static stiffness of the prior art core 12 was calculated to be four times the Young's modulus. It can thus be seen that the core 22 of the present invention is significantly stiffer than the core 12 of the prior art.

The calculations presented herein are merely approximations. As previously noted, the viscoelastic material comprising the first and second viscoelastic layers 30, 32 need not be identical. Additionally, a wide variety of materials may be used for the strengthening layer. Furthermore, the present invention may be practiced using any shape of damping structure; a cylindrical structure was chosen only by way of example. Changing any of these parameters would significantly affect the calculations above. However, it can generally be seen by one skilled in the art that addition of a continuous strengthening layer 28 within the core 22 significantly increases the stiffness therein.

For ease of description, a rectangular damping structure was described herein. It should be noted, however, that the present invention may be practiced by providing any internally damped composite structure having at least one wall with a cross-section substantially similar to the rectangular damping structure 20 described herein and shown in FIG. 2. That is, the present invention includes any internally damped composite structure having at least one wall comprising first and second constraining layers surrounding a core, with the core comprising first and second viscoelastic layers surrounding a strengthening layer.

While the best mode for carrying out the invention has been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent way other than as specifically described herein.

1. A vibration damping structure comprising:
a continuous strengthening layer;
first and second viscoelastic layers surrounding said continuous strengthening layer; and
a constraining layer adjacent one of said first and second viscoelastic layers.

2. The vibration damping structure of claim 1, wherein said strengthening layer comprises a material having a relatively high stiffness with respect to said first and second viscoelastic layers.

3. The vibration damping structure of claim 1, wherein said first and second viscoelastic layers comprise a first viscoelastic material.

4. The vibration damping structure of claim 1, wherein said first viscoelastic layer comprises a first viscoelastic material, and said second viscoelastic layer comprises a second viscoelastic material.

5. The vibration damping structure of claim 1, wherein said first and second viscoelastic layers have a substantially equal thickness.

6. The vibration damping structure of claim 1, further including a second constraining layer adjacent the other of said first and second viscoelastic layers.

7. An internally damped composite structure having at least one wall comprising:
a continuous strengthening layer;
first and second viscoelastic layers surrounding said continuous strengthening layer;
a first constraining layer adjacent one of said first and second viscoelastic layers; and
a second constraining layer adjacent the other of said first and second viscoelastic layers.

8. The internally damped composite structure of claim 7, wherein said strengthening layer comprises a material having a relatively high stiffness with respect to said first and second viscoelastic layers.

9. The internally damped composite structure of claim 7, wherein said first and second viscoelastic layers comprise a first viscoelastic material.

10. The internally damped composite structure of claim 7, wherein said first viscoelastic layer comprises a first viscoelastic material, and said second viscoelastic layer comprises a second viscoelastic material.

11. The internally damped composite structure of claim 7, wherein said first and second viscoelastic layers have a substantially equal thickness.

12. A vibration damping structure comprising:
first and second constraining layers; and
a core disposed between said first and second constraining layers, said core comprising first and second viscoelastic layers surrounding a continuous strengthening layer;
said strengthening layer comprising a material having a relatively high stiffness with respect to said first and second viscoelastic layers.

13. The vibration damping structure of claim 12, wherein said first and second viscoelastic layers comprise a first viscoelastic material.

14. The vibration damping structure of claim 12, wherein said first viscoelastic layer comprises a first viscoelastic material, and said second viscoelastic layer comprises a second viscoelastic material.

15. The vibration damping structure of claim 12, wherein said first and second viscoelastic layers have a substantially equal thickness.
